(19) United States
(12) Patent Application Publication
(10) Pub. No.: US 2025/0343614 A1
(43) Pub. Date: Nov. 6, 2025

(54) METHOD AND NETWORK DEVICE FOR PTP CLOCK SYNCHRONIZATION

(71) Applicant: Telefonaktiebolaget LM Ericsson (publ), Stockholm (SE)

(72) Inventors: Yao Peng, Beijing (CN); Jun Wang, Beijing (CN); Ruyi Sun, Beijing (CN); Xing Qin, Beijing (CN)

(21) Appl. No.: 18/867,068

(22) PCT Filed: Jun. 7, 2022
(86) PCT No.: PCT/CN2022/097409

§ 371 Date: Nov. 19, 2024

(51) Int. Cl. H04J 3/06

(52) U.S. Cl. CPC H04J 3/0667; H04J 3/0641

(57) ABSTRACT

A method and a network device are disclosed for precision time protocol (PTP) clock synchronization. According to an embodiment, the network device determines whether the network device is in one of a first state where a reception of an announce message from a PTP clock source is interrupted due to a local change at the network device, and a second state where the PTP clock source is restored after a predetermined restoration time, or the reception of the announce message from the PTP clock source is recovered after the local change. When determining that the network device is in one of the first state and the second state, the network device uses the PTP clock source as a candidate PTP master, without waiting for the predetermined restoration time.

### TECHNICAL FIELD

Embodiments of the disclosure generally relate to communication, and, more particularly, to a method and a network device for precision time protocol (PTP) clock synchronization.

### BACKGROUND

This section introduces aspects that may facilitate better understanding of the present disclosure. Accordingly, the statements of this section are to be read in this light and are not to be understood as admissions about what is in the prior art or what is not in the prior art.

The institute of electrical and electronics engineers (IEEE) 1588 version 2 (V2), also known as precision time protocol (PTP), is an industry-standard protocol that enables the precise transfer of frequency and time to synchronize clocks over packet-based Ethernet networks. It synchronizes the local slave clock on each network device with a system grandmaster (GM) clock and uses traffic timestamping, with sub-nanoseconds granularity, to deliver the very high accuracies of synchronization needed to ensure the stability of base station frequency and handovers. Timestamps between master and slave devices are sent within specific PTP packets and in its basis form the protocol is administration-free.

According to IEEE1588v2, BC is a boundary clock with multiple PTP ports connecting to multiple GMs. One of them may be “Slave” state, and the remaining PTP ports should be “Passive” or “Master” state, which is decided by best master clock algorithm (BMCA). The “Slave” port will have higher priority to calibrate the frequency and time from received timestamped packets. The frequency and time will be delivered to downstream clock via the “Master” ports.

The international telecommunications unit-telecommunication (ITU-T) G.8275.1 profile defines a specific architecture to allow the distribution of phase/time with full timing support network. The ITU-T G.8275.2 profile defines a specific architecture to allow the distribution of phase/time with partial timing support (PTS) from the network. These profiles are all based on the PTP defined in IEEE1588v2.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for PTP clock synchronization. In particular, one of the problems to be solved by the disclosure is that the existing solution for PTP clock source selection could not work well in some scenarios.

According to a first aspect of the disclosure, there is provided a method performed by a network device. The method may comprise determining whether the network device is in one of a first state where a reception of an announce message from a precision time protocol (PTP) clock source is interrupted due to a local change at the network device, and a second state where the PTP clock source is restored after a predetermined restoration time, or the reception of the announce message from the PTP clock source is recovered after the local change. The method may further comprise, when determining that the network device is in one of the first state and the second state, using the PTP clock source as a candidate PTP master, without waiting for the predetermined restoration time.

In this way, the PTP clock source selection can be improved in some scenarios, thereby improving the performance, robustness and stability of PTP clock synchronization network.

In an embodiment of the disclosure, the method may further comprise, when determining that the network device is not in one of the first state and the second state, using the PTP clock source as a candidate PTP master after the PTP clock source is restored based on the predetermined restoration time.

In an embodiment of the disclosure, whether the network device is in one of the first state and the second state may be determined based on a state machine of the network device. The state machine may be configured to switch between the first state, the second state, a third state where the reception of the announce message from the PTP clock source is interrupted due to an external change that is external to the network device, and a fourth state where the reception of the announce message from the PTP clock source is recovered but the predetermined restoration time has not elapsed.

In an embodiment of the disclosure, the state machine may have a parameter indicating, for the fourth state, remaining time required for restoring the PTP clock source. The parameter may take a value that equals the predetermined restoration time when the fourth state is entered, and decreases with time.

In an embodiment of the disclosure, determining whether the network device is in one of the first state and the second state may comprise, when the reception of the announce message from the PTP clock source is recovered after it is interrupted, determining offsets between a clock of the network device and a clock of the PTP clock source for a predetermined time period, based on timestamps related to PTP messages communicated between the network device and the PTP clock source. Determining whether the network device is in one of the first state and the second state may further comprise determining whether the network device is in the second state, based on the offsets determined in the predetermined time period.

In an embodiment of the disclosure, the network device may be determined to be in the second state when the offsets determined in the predetermined time period are within a predetermined range.

In an embodiment of the disclosure, the local change may comprise one or more of: the network device being reloaded; a line card of the network device being reloaded; a process related to PTP in the network device being restarted; a configuration of a PTP port of the network device being changed; and a configuration of a PTP clock of the network device being changed.

In an embodiment of the disclosure, using the PTP clock source as a candidate PTP master may comprise adding an announce message from the PTP clock source into a best master clock algorithm (BMCA) list.

In an embodiment of the disclosure, the network device may be configured to act as one of: a boundary clock (BC); an ordinary clock (OC); and a transparent clock (TC).

According to a second aspect of the disclosure, there is provided a network device. The network device may comprise at least one processor and at least one memory. The at least one memory may contain instructions executable by the at least one processor, whereby the network device may be operative to determine whether the network device is in one of a first state where a reception of an announce message from a PTP clock source is interrupted due to a local change at the network device, and a second state where the PTP clock source is restored after a predetermined restoration time, or the reception of the announce message from the PTP clock source is recovered after the local change. The network device may be further operative to, when determining that the network device is in one of the first state and the second state, use the PTP clock source as a candidate PTP master, without waiting for the predetermined restoration time.

In this way, the PTP clock source selection can be improved in some scenarios, thereby improving the performance, robustness and stability of PTP clock synchronization network.

In an embodiment of the disclosure, the network device may be further operative to, when determining that the network device is not in one of the first state and the second state, use the PTP clock source as a candidate PTP master after the PTP clock source is restored based on the predetermined restoration time.

In an embodiment of the disclosure, the network device may be operative to determine whether the network device is in one of the first state and the second state based on a state machine of the network device. The state machine may be configured to switch between the first state, the second state, a third state where the reception of the announce message from the PTP clock source is interrupted due to an external change that is external to the network device, and a fourth state where the reception of the announce message from the PTP clock source is recovered but the predetermined restoration time has not elapsed.

In an embodiment of the disclosure, the state machine may have a parameter indicating, for the fourth state, remaining time required for restoring the PTP clock source. The parameter may take a value that equals the predetermined restoration time when the fourth state is entered, and decreases with time.

In an embodiment of the disclosure, the network device may be operative to determine whether the network device is in one of the first state and the second state by: when the reception of the announce message from the PTP clock source is recovered after it is interrupted, determining offsets between a clock of the network device and a clock of the PTP clock source for a predetermined time period, based on timestamps related to PTP messages communicated between the network device and the PTP clock source. The network device may be operative to determine whether the network device is in one of the first state and the second state by determining whether the network device is in the second state, based on the offsets determined in the predetermined time period.

In an embodiment of the disclosure, the network device may be determined to be in the second state when the offsets determined in the predetermined time period are within a predetermined range.

In an embodiment of the disclosure, the local change may comprise one or more of: the network device being reloaded; a line card of the network device being reloaded; a process related to PTP in the network device being restarted; a configuration of a PTP port of the network device being changed; and a configuration of a PTP clock of the network device being changed.

In an embodiment of the disclosure, the network device may be operative to use the PTP clock source as a candidate PTP master by adding an announce message from the PTP clock source into a BMCA list.

In an embodiment of the disclosure, the network device may be configured to act as one of: a BC; an OC; and a TC.

According to a third aspect of the disclosure, there is provided a computer program product. The computer program product may contain instructions which when executed by at least one processor, cause the at least one processor to perform the method according to the above first aspect.

According to a fourth aspect of the disclosure, there is provided a computer readable storage medium. The computer readable storage medium may store thereon instructions which when executed by at least one processor, cause the at least one processor to perform the method according to the above first aspect.

According to a fifth aspect of the disclosure, there is provided a network device. The network device may comprise a determination module for determining whether the network device is in one of a first state where a reception of an announce message from a PTP clock source is interrupted due to a local change at the network device, and a second state where the PTP clock source is restored after a predetermined restoration time, or the reception of the announce message from the PTP clock source is recovered after the local change. The network device may further comprise a control module for, when determining that the network device is in one of the first state and the second state, using the PTP clock source as a candidate PTP master, without waiting for the predetermined restoration time.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIGS. 1A-1B are flowcharts illustrating the BMCA algorithm;

FIG. 2 is a diagram illustrating a scenario of PTP clock synchronization;

FIG. 3 is a diagram illustrating another scenario of PTP clock synchronization;

FIG. 4 is a flowchart illustrating a method performed by a network device according to an embodiment of the disclosure;

FIG. 5 is a flowchart illustrating a method performed by a network device according to an embodiment of the disclosure;

FIG. 6 is a flowchart illustrating a method performed by a network device according to an embodiment of the disclosure;

FIG. 7 is a flowchart for explaining the method of FIG. 4;

FIG. 8 is a block diagram showing an apparatus suitable for use in practicing some embodiments of the disclosure;

FIG. 9 is a block diagram showing a network device according to an embodiment of the disclosure;

FIG. 10 is a diagram illustrating a state machine of a network device according to an embodiment of the disclosure;

FIG. 11 is a block diagram illustrating a network device according to an embodiment of the disclosure;

FIG. 12 is a flowchart illustrating a method performed by a network device according to an embodiment of the disclosure; and

FIG. 13 is a flowchart illustrating a method performed by a network device according to an embodiment of the disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

The ITU-T G.8275.1 profile uses an alternate best master clock algorithm (BMCA), which is defined in “6.3 Protection aspects and Alternate BMCA” of “Rec. ITU-T G.8275.1/Y.1369.1” to select a time source. The G.8275.2 profile has the same process as G.8275.1 profile. Thus, the G.8275.1 profile is used here as an example.

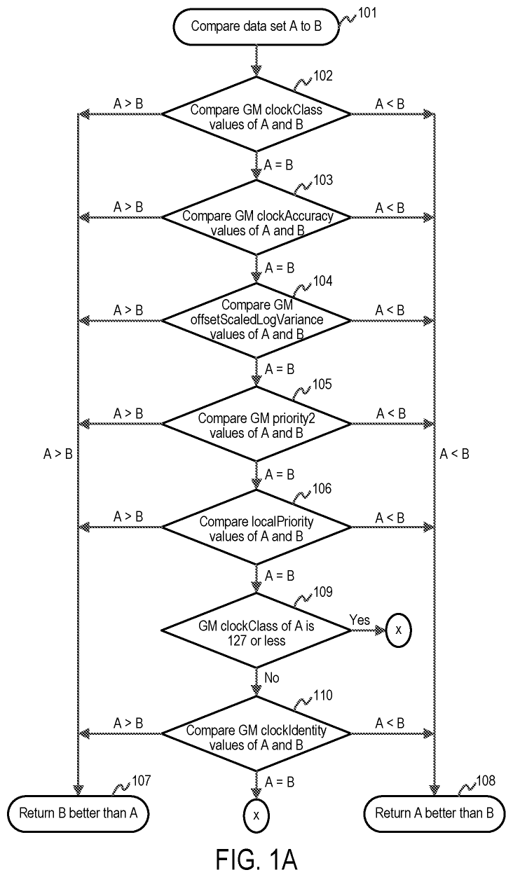

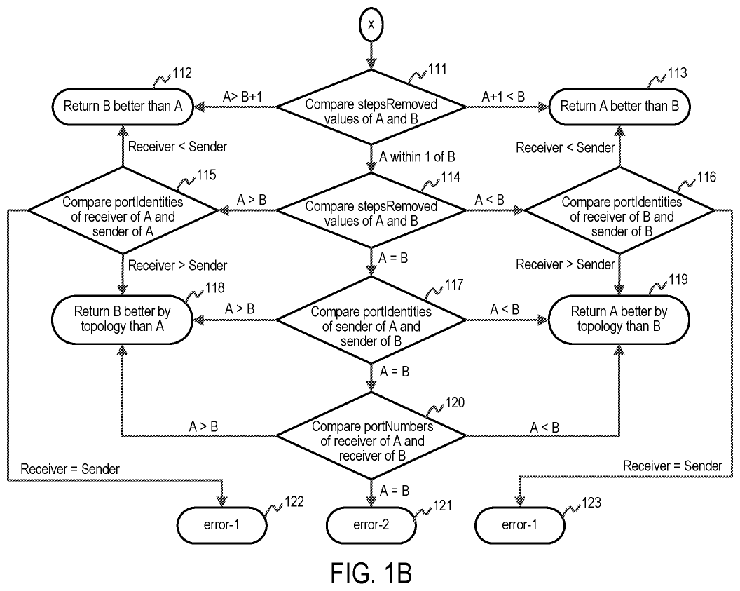

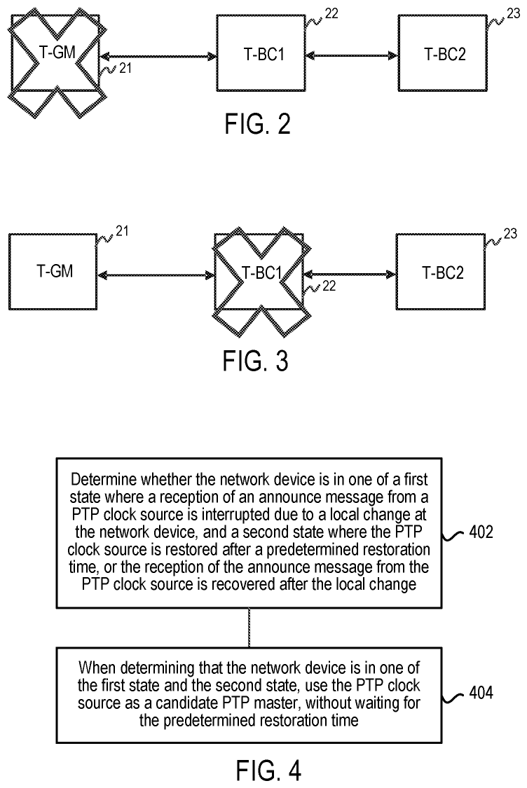

FIGS. 1A and 1B are FIG. 2 and FIG. 3 of G.8275.1/Y.1369.1, which illustrate the Alternate BMCA algorithm. At step 101, data set A is compared to data set B. At step 102, GM clockClass values of A and B are compared. The field GM clockClass presents the clock class of the grand master. It is an attribute that defines a clock's international atomic time (TAI) traceability. The candidate values are defined in IEEE1588 2018. If GM clockClass values of A and B are equal to each other, the process proceeds to step 103 where GM clockAccuracy values of A and B are compared. The field GM clockAccuracy is used to present the accuracy of the grand master. For example, it can be 0×20, which means the clock has accuracy of 25 ns. The candidate values are defined in IEEE1588 2018. If GM clockAccuracy values of A and B are equal to each other, the process proceeds to step 104 where GM offsetScaledLog Variance values of A and B are compared. The field GM offsetScaledLog Variance is used to present the dynamic accuracy behavior of the grand master. It presents the rate of change of GM accuracy which presents the static accuracy. If GM offsetScaledLogVariance values of A and B are equal to each other, the process proceeds to step 105 where GM priority2 values of A and B are compared. The field GM Priority2 is a user configurable designation on grand master that presents the priority of the grand master clock. The value can be 0 to 255. A smaller value has higher priority. If GM priority2 values of A and B are equal to each other, the process proceeds to step 106 where localPriority values of A and B are compared. If localPriority values of A and B are equal to each other, the process proceeds to step 109.

In any one of steps 102-106, if the corresponding value of A is greater than the corresponding value of B, the process proceeds to step 107 where B being better than A is returned. On the other hand, in any one of steps 102-106, if the corresponding value of A is smaller than the corresponding value of B, the process proceeds to step 108 where A being better than B is returned.

At step 109, whether GM clockClass of A is 127 or less is determined. If the determination result is positive, the process proceeds to step 111. On the other hand, if the determination result is negative, the process proceeds to step 110 where GM clockIdentity values of A and B are compared. The field GM clockIdentity is an identifier (ID) to identify a grand master clock. If GM clockIdentity value of A is greater than that of B, the process proceeds to step 107 where B being better than A is returned. If GM clockIdentity value of A is smaller than that of B, the process proceeds to step 108 where A being better than B is returned. If GM clockIdentity values of A and B are equal to each other, the process proceeds to step 111.

At step 111, stepsRemoved values of A and B are compared. If stepsRemoved value of A is greater than a sum of stepsRemoved value of B and 1, the process proceeds to step 112 where B being better than A is returned. If a sum of stepsRemoved value of A and 1 is smaller than stepsRemoved value of B, the process proceeds to step 113 where A being better than B is returned. If a difference between stepsRemoved values of A and B is above −1 and below 1, the process proceeds to step 114.

At step 114, stepsRemoved values of A and B are compared. If stepsRemoved value of A is greater than that of B, the process proceeds to step 115 where portIdentities of receiver of A and sender of A are compared. If portIdentities of receiver of A is smaller than portIdentities of sender of A, the process proceeds to step 112. If portIdentities of receiver of A is greater than portIdentities of sender of A, the process proceeds to step 118 where B being better by topology than A is returned. If portIdentities of receiver of A is equal to portIdentities of sender of A, the process proceeds to step 122 where error-1 is detected.

If stepsRemoved value of A is smaller than that of B, the process proceeds to step 116 where portIdentities of receiver of B and sender of B are compared. If portIdentities of receiver of B is smaller than portIdentities of sender of B, the process proceeds to step 113. If portIdentities of receiver of B is greater than portIdentities of sender of B, the process proceeds to step 119 where A being better by topology than B is returned. If portIdentities of receiver of B is equal to portIdentities of sender of B, the process proceeds to step 123 where error-1 is detected.

If stepsRemoved value of A is equal to that of B, the process proceeds to step 117 where portIdentities of sender of A and sender of B are compared. If portIdentities of sender of A is greater than that of B, the process proceeds to step 118. If portIdentities of sender of A is smaller than that of B, the process proceeds to step 119. If portIdentities of sender of A is equal to that of B, the process proceeds to step 120.

At step 120, portNumbers of receiver of A and receiver of B are compared. If portNumbers of receiver of A is greater than that of B, the process proceeds to step 118. If portNumbers of receiver of A is smaller than that of B, the process proceeds to step 119. If portNumbers of receiver of A is equal to that of B, the process proceeds to step 121 where error-2 is detected.

In the real network, the synchronization of frequency and time are the key factors that would affect the performance of the whole network. The traditional clock selection process is based on the “Alternate BMCA algorithm” mentioned above. Thus, its clock selection is based on the clock parameters but has not considered the real stability of the clock source. If the clock source is restarted and recovered, the instability would be delivered to downstream and affect the whole network.

FIG. 2 illustrates a first scenario that may happen in the customer network. As shown, the telecom grandmaster (T-GM) 21 acts as the clock source of the whole network, and the telecom boundary clock 22 (T-BC1) and telecom boundary clock 23 (T-BC2) follow the T-GM 21. The T-GM is restarted or upgraded as the requirement. Then, the T-BC1 enters into holdover-in-spec (e.g. clockclass=135) or holdover-out-of-spec (e.g. clockclass=165) state which may be decided by the holdoverBudget.

During the T-GM is recovering, the clockclass of the T-GM may be decided by the software or hardware designing. If the clockclass change is as 150->140->7->6, the T-GM may be chosen as the best clock source by comparing the clockclass at the beginning. But at that time, the frequency and the time of the T-GM may be in unstable state. For example, the time is still the initial value: 1980 01-01 xxxxxxxxxx. The T-BC1 should adjust the local clock once the message arrived. It would cause the whole network to have the problem and disturb the business service.

The common solution to solve the issue is that when the T-GM is planned to restart or perform release upgrade, the communication between the T-GM and the downstream is cut off by shutting down the link or plugging out the link; and after the T-GM is ready (stable enough), the communication is recovered. It is not convenience to manage or maintain the network.

Another solution to solve the issue is using “wait-to-restore time function” mentioned in “ITU-T G.8265.1/Y.1365.1” and “ITU-T G.781”. If “wait-to-restore time” function is triggered, the traffic or sync chain will be recovered after the time expires. So, the longer the restore time, the more time the traffic or sync chain will take to recover. The function can be applied to some scenarios such as reloaded Grandmaster as mentioned above.

However, for some scenarios, the applying of the function would obviously lengthen the recovery time taken by the traffic or sync chain and then impact the whole business. For example, FIG. 3 illustrates a second scenario that may happen in the customer network. As shown, the T-GM 21 acts as the clock source of the whole network, and the T-BC1 and T-BC2 follow the T-GM. The T-BC1 is restarted or upgraded as the requirement. Then, after the T-BC1 is recovered, the T-GM sends announce messages with clockclass 6 to the T-BC1. In this second scenario, if the “wait-to-restore time” function was applied to the T-BC1, the recovery time taken by the traffic or sync chain would be obviously lengthened. Therefore, it would be advantageous to skip the “wait-to-restore time” function in some scenarios.

The present disclosure proposes an improved solution for PTP clock synchronization. The solution may be applicable to any network device which has PTP capability and needs to carry out PTP clock source selection. Examples of the network device include, but not limited to, a router, a switch, a bridge, a gateway, and the like. The network device may also be a “multiple services network device” that provides support for multiple networking functions (e.g., routing, bridging, switching, Layer 2 aggregation, session border control, quality of service, and/or subscriber management), and/or provides support for multiple application services (e.g., data, voice, and video). When carrying out PTP clock source selection, the network device may act as any one of a BC, an ordinary clock (OC), a transparent clock (TC), and the like. Hereinafter, the solution will be described in detail with reference to FIGS. 4-13.

FIG. 4 is a flowchart illustrating a method performed by a network device according to an embodiment of the disclosure. At block 402, the network device determines whether the network device is in one of a first state where a reception of an announce message from a PTP clock source is interrupted due to a local change at the network device, and a second state where the PTP clock source is restored after a predetermined restoration time, or the reception of the announce message from the PTP clock source is recovered after the local change. For example, the announce message may be used for indicating the capabilities of a clock node to the other clock nodes so that a master-slave hierarchy can be established. Examples of the local change at the network device may include, but not limited to: the network device being reloaded; a line card of the network device (e.g. a task processing card that can be inserted into or plugged out from a chassis device) being reloaded; a process related to PTP in the network device being restarted; a configuration of a PTP port of the network device (e.g. local-priority, shutdown/no shutdown, etc.) being changed; a configuration of a PTP clock of the network device (e.g. local-priority, priority 1, priority 2, shutdown/no shutdown, no PTP-port/PTP-port) being changed, or any other local change that can cause the reception of the announce message from the PTP clock source to be interrupted. The predetermined restoration time may be similar to the restore time used in “wait-to-restore time function” which is defined in “ITU-T G.8265.1/Y.1365.1” and “ITU-T G.781”.

As a first option, whether the network device is in one of the first state and the second state may be determined based on a state machine of the network device. The state machine may be configured to switch between the first state, the second state, a third state where the reception of the announce message from the PTP clock source is interrupted due to an external change that is external to the network device, and a fourth state where the reception of the announce message from the PTP clock source is recovered but the predetermined restoration time has not elapsed. For example, the external change may be the PTP clock source being restarted or upgraded, or any other external change that can cause the reception of the announce message from the PTP clock source to be interrupted.

For example, the state machine may have two inputs and a state variable (or parameter). The first input may indicate the status of the reception of the announce message from the PTP clock source. If the announce message is periodically received from the PTP clock source, the first input may indicate a “presence” status. On the other hand, if the announce message is not received from the PTP clock source in one or more transmission period of the announce message, the first input may indicate an “absence” status. The second input may indicate whether a local change has occurred at the network device. The second input may be determined from a local log that records various events occurring at the network device. The state variable may indicate, for the fourth state, remaining time required for restoring the PTP clock source. Since the restoration of the PTP clock source is not triggered or is finished in the first state, the second state and the third state, the state variable takes the value of zero when the state machine is in any one of the first to third states.

When the first input changes from the “presence” status to the “absence” status and the second input indicates that a local change has not occurred at the network device, the state machine enters the third state. Then, when the first input changes from the “absence” status to the “presence” status and the second input indicates that a local change has not occurred at the network device, the state machine enters the fourth state. When the fourth state is entered, the state variable takes a value that equals the predetermined restoration time and decreases with time. When the value of the state variable decreases to zero, the state machine enters the second state. Note that in the case where the state machine is in the fourth state, if the first input changes from the “presence” status to the “absence” status and the second input indicates that a local change has not occurred at the network device, the state machine returns back to the third state.

When the first input changes from the “presence” status to the “absence” status and the second input indicates that a local change has occurred at the network device, the state machine enters the first state. Then, when the first input changes from the “absence” status to the “presence” status, the state machine enters the second state. Note that in the case where the state machine is in the second state, if the second input indicates that a local change has occurred at the network device, the state machine enters the first state. Also note that in the case where the state machine is in the second state, when the first input changes from the “presence” status to the “absence” status and the second input indicates that a local change has not occurred at the network device, the state machine enters the third state.

As a second option, block 402 may be implemented as blocks 708-710 of FIG. 7. At block 708, when the reception of the announce message from the PTP clock source is recovered after it is interrupted, the network device determines offsets between a clock of the network device and a clock of the PTP clock source for a predetermined time period, based on timestamps related to PTP messages communicated between the network device and the PTP clock source. For example, the PTP messages may comprise a plurality of message groups communicated during the predetermined time period. Each message group may include a Sync message, a Follow Up message, a Delay Request message and a Delay Response message (note that the Follow Up message may be omitted when one-step mode is used). Accordingly, the timestamps may comprise a plurality of timestamp groups corresponding to the plurality of message groups. Each timestamp group may include a first timestamp (denoted as t1) at which the Sync message is sent from the PTP clock source acting as a master, a second timestamp (denoted as t2) at which the Sync message is received by the network device, a third timestamp (denoted as t3) at which the Delay Request message is sent from the network device, and a fourth time stamp (denoted as t4) at which the Delay Request message is received by the PTP clock source. Then, for each timestamp group, the corresponding offset (denoted as Offset) may be determined as 0.5 multiplied by a difference between a first difference between the second and first timestamps and a second difference between the fourth and third timestamps. This may be expressed as:

$$Offset = [ ( t 2 - t 1 ) - ( t 4 - t 3 ) ] / 2.$$

At block 710, the network device determines whether the network device is in the second state, based on the offsets determined in the predetermined time period. As an exemplary example, if the offsets determined in the predetermined time period are within a predetermined range (meaning that the PTP clock source is stable), the network device may be determined to be in the second state. On the other hand, if the offsets determined in the predetermined time period are not within the predetermined range, the network device may be determined to be in the fourth state mentioned above. Note that block 710 may be implemented in any other suitable way (e.g. by using a statistical metric of the offsets).

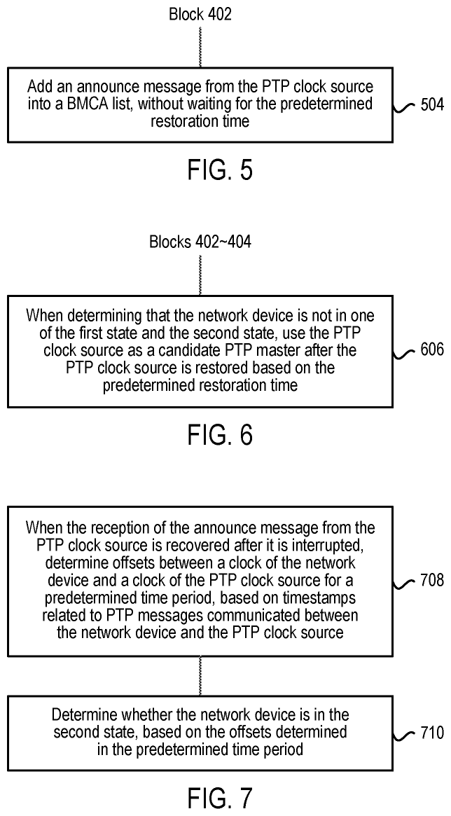

Referring back to FIG. 4, when determining that the network device is in one of the first state and the second state, the network device uses the PTP clock source as a candidate PTP master, without waiting for the predetermined restoration time. For example, the PTP clock source may be used as a candidate PTP master by adding an announce message from the PTP clock source into a best master clock algorithm (BMCA) list of the network device, as shown in block 504 of FIG. 5. With the method of FIG. 4, the PTP clock source selection can be improved in some scenarios, thereby improving the performance, robustness and stability of PTP clock synchronization network.

FIG. 6 is a flowchart illustrating a method performed by a network device according to an embodiment of the disclosure. As shown, the method comprises blocks 402-404 described above and block 606. At block 606, when determining that the network device is not in one of the first state and the second state, the network device uses the PTP clock source as a candidate PTP master after the PTP clock source is restored based on the predetermined restoration time. For example, in the first option described above with respect to block 402, when determining that the network device is in the third state or the fourth state based on the state machine, the value of the state variable indicating the remaining restoration time may be used for restoring the PTP clock source. After the remaining restoration time has elapsed, the PTP clock source may be used as a candidate PTP master. For example, in the second option described above with respect to block 402, when the offsets determined in the predetermined time period are not within the predetermined range, a remaining time which equals a difference between the predetermined restoration time and the predetermined time period may be used for restoring the PTP clock source (in this case the predetermined restoration time is configured to be greater than or equal to the predetermined time period). After the remaining time has elapsed, the PTP clock source may be used as a candidate PTP master. It is also possible that the predetermined restoration time is configured separately from the predetermined time period. In this case, after the predetermined time period plus the predetermined restoration time, the PTP clock source may be used as a candidate PTP master. With the method of FIG. 6, the instability of the PTP clock source can be prevented from being delivered to the downstream side thereof.

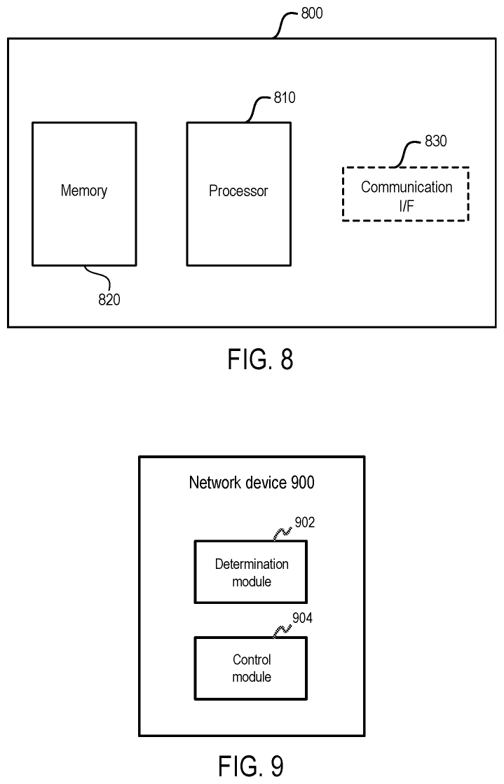

FIG. 8 is a block diagram showing an apparatus suitable for use in practicing some embodiments of the disclosure. For example, the network device described above may be implemented through the apparatus 800. As shown, the apparatus 800 may include a processor 810, a memory 820 that stores a program, and optionally a communication interface 830 for communicating data with other external devices through wired and/or wireless communication.

The program includes program instructions that, when executed by the processor 810, enable the apparatus 800 to operate in accordance with the embodiments of the present disclosure, as discussed above. That is, the embodiments of the present disclosure may be implemented at least in part by computer software executable by the processor 810, or by hardware, or by a combination of software and hardware.

The memory 820 may be of any type suitable to the local technical environment and may be implemented using any suitable data storage technology, such as semiconductor based memory devices, flash memories, magnetic memory devices and systems, optical memory devices and systems, fixed memories and removable memories. The processor 810 may be of any type suitable to the local technical environment, and may include one or more of general purpose computers, special purpose computers, microprocessors, digital signal processors (DSPs) and processors based on multi-core processor architectures, as non-limiting examples.

FIG. 9 is a block diagram showing a network device according to an embodiment of the disclosure. As shown, the network device 900 comprises a determination module 902 and a control module 904. The determination module 902 may be configured to determine whether the network device is in one of a first state where a reception of an announce message from a PTP clock source is interrupted due to a local change at the network device, and a second state where the PTP clock source is restored after a predetermined restoration time, or the reception of the announce message from the PTP clock source is recovered after the local change, as described above with respect to block 402. The control module 904 may be configured to, when determining that the network device is in one of the first state and the second state, use the PTP clock source as a candidate PTP master, without waiting for the predetermined restoration time, as described above with respect to block 404. The modules described above may be implemented by hardware, or software, or a combination of both.

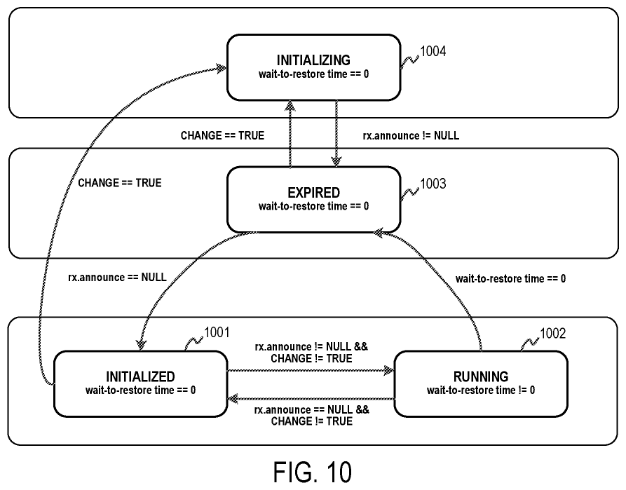

For ease of understanding, FIG. 10 illustrates an exemplary example of a state machine of a network device according to an embodiment. The state machine may be maintained for each PTP-Port to manage the “wait-to-restore time” function. As shown, the state machine “Wait-To-Restore” can switch between the INITIALIZED state 1001 (corresponding to the third state described above), the RUNNING state 1002 (corresponding to the fourth state described above), the EXPIRED state 1003 (corresponding to the second state described above) and the INITIALIZING state 1004 (corresponding to the first state described above). Note that in INITIALIZED, INITIALIZING and RUNNING states, all PTP packages are dropped. The state machine has two inputs. One input is the reception status of announce message (e.g. denoted as rx.announce), which may be “receive announce message” (e.g. rx.announce !=NULL, meaning that the announce message is received periodically), or “no announce message received” (e.g. rx.announce==NULL, meaning that the announce message is not received in one or more transmission period of the announce message). The other input is CHANGE which indicates whether a local change has occurred at the network device. For example, this input may be configured as:

If {
process restart
ptp-port change configuration
ptp-clock change configuration
reload line card
reload node
} CHANGE = TRUE.

When the reception status of announce message changes from “receive announce message” to “no announce message received” with the CHANGE==FALSE, the Wait-To-Restore state (i.e. the state of the state machine) is set to INITIALIZED. For example, after executing a clear Wait-To-Restore command, the state is set to INITIALIZED. Thus, if the Wait-To-Restore state is INITIALIZED, Wait-To-Restore time is cleared (set to 0).

When the current Wait-To-Restore state is INITIALIZED, if PTP-Port reception status of announce message changes from “no packets received” to “receive packets” with the CHANGE==FALSE, the state is set to RUNNING. If the Wait-To-Restore state is RUNNING, Wait-To-Restore time is set to the configuration value and reduces (or decreases) every second.

When Wait-To-Restore time is expired, the state is set to EXPIRED. If the CHANGE is TRUE (e.g. process restart, node reload, line card reload, PTP-Clock configuration change, PTP-Port configuration change), the Wait-To-Restore state is supposed to change from EXPIRED to INITIALIZING. When the current Wait-To-Restore state is EXPIRED, if PTP-Port reception status of announce message changes from “receive packets” to “no packets received” with the CHANGE==FALSE, the Wait-To-Restore state is set to INITIALIZED.

When configuring a PTP-Port (Create a PTP-Port), the Wait-To-Restore state is set to INITIALIZING. If the Wait-To-Restore state is INITIALIZING, Wait-To-Restore time is cleared (set to 0). When the current Wait-To-Restore state is INITIALIZING, if PTP-Port reception status of announce message changes from “no packets received” to “receive packets”, the Wait-To-Restore state is set to EXPIRED.

Note that when the current Wait-To-Restore state is RUNNING, if PTP-Port reception status of announce message changes from “receive packets” to “no packets received” with the CHANGE==FALSE, the Wait-To-Restore state is set to INITIALIZED. In addition, when the current Wait-To-Restore state is INITIALIZED, if CHANGE is TRUE, the Wait-To-Restore state is set to INITIALIZING.

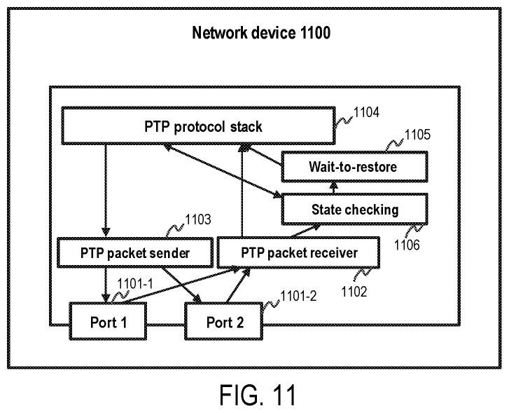

FIG. 11 illustrates a network device according to an embodiment. As shown, the network device 1100 comprises two ports 1101-1, 1101-2, a PTP packet receiver 1102, a PTP packet sender 1103, and a PTP protocol stack 1104. Although two ports are shown in FIG. 11, the network device may comprise more ports or less port depending on the specific application scenario. As enhancements introduced by this embodiment, the network device 1100 comprises a state checking module 1106 and a wait-to-restore module 1105.

As a first option, the state checking module 1106 comprises the “wait-to-restore time” function state machine shown in FIG. 10. If the state is INITAILIZING and EXPIRED, the result of the state checking is TRUE. If the state is INITIALIZED and RUNNING, the result of the state checking is FALSE.

As a second option, a “preprocessing mechanism” is used before the announce message is added into the BMCA list. When the announce message of a grandmaster arrives, the current PTP-Port executes the timestamps (t1, t2, t3 and t4) interaction process as SLAVE PTP-Port for a while, but does not add the announce message into the BMCA list. During this time, the PTP-Port can calculate the time information from the received t1, t2, t3 and t4. If the stability of the grandmaster is good enough, then the announce message of the grandmaster is added into the BMCA list. If the stability of the grandmaster is not good enough, then the “wait-to-restore time” function is started.

For example, the state checking module 1106 may obtain timestamp calculated results from the PTP protocol stack 1104. If the stability of the grandmaster is good enough, the result of the state checking is TRUE. If the stability of Grandmaster is not good enough, the result of the state checking is FALSE.

For both the above two options, the wait-to-restore module 1105 may be triggered by the result of the state checking. If the result of the state checking is FALSE, the wait-to-restore timer is started. If the result is TRUE, the announce message from the grandmaster can be added into the BMCA list immediately.

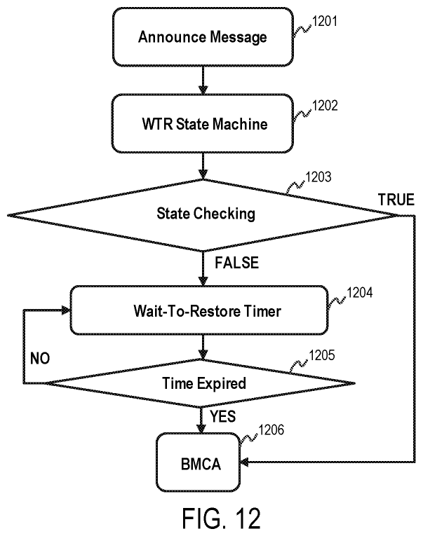

FIG. 12 illustrates an exemplary process which may be performed by the network device of FIG. 11. This process corresponds to the case where the network device 1100 uses the state machine shown in FIG. 10. At block 1201, an announce message is received. The process of FIG. 12 may be performed when every announce message is received, or when the reception status of announce message changes from “no packets received” to “receive packets”. At block 1202, the wait-to-restore (WTR) state machine determines its state. At block 1203, the state of the state machine is checked. If the result of the state checking is TRUE, the announce message from the grandmaster is added into the BMCA list at block 1206. On the other hand, if the result of the state checking is FALSE, the wait-to-restore timer is run at block 1204. At block 1205, whether the time has expired is checked. If the time has not expired, the process proceeds to block 1204. If the time has expired, the announce message from the grandmaster is added into the BMCA list at block 1206.

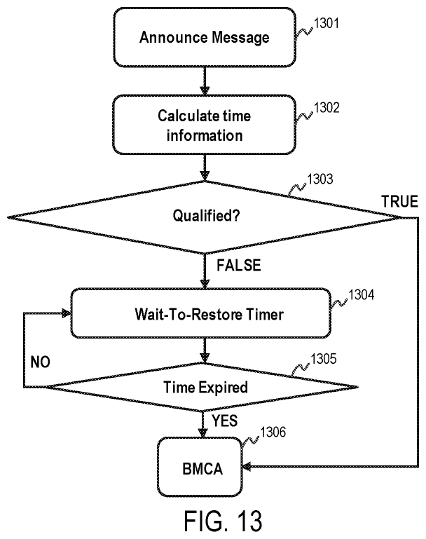

FIG. 13 illustrates an exemplary process which may be performed by the network device of FIG. 11. This process corresponds to the case where the network device 1100 performs state checking by using timestamp calculated results. At block 1301, an announce message is received. The process of FIG. 13 may be performed when the reception status of announce message changes from “no packets received” to “receive packets”. At block 1302, time information is calculated based on timestamps related to PTP messages. At block 1203, whether the clock of the grandmaster is stable is checked. If the result of the state checking is TRUE, the announce message from the grandmaster is added into the BMCA list at block 1306. On the other hand, if the result of the state checking is FALSE, the wait-to-restore timer is run at block 1304. At block 1305, whether the time has expired is checked. If the time has not expired, the process proceeds to block 1304. If the time has expired, the announce message from the grandmaster is added into the BMCA list at block 1306.

To illustrate the effect of the embodiments of FIG. 12 and FIG. 13, the first scenario of FIG. 2 and the second scenario of FIG. 3 will be considered here. In the first scenario, if the T-GM is restarted or upgraded as the requirement, the history of the received announce messages is cleared in the T-BC1. The T-BC1 enters into holdover-in-spec (clockclass=135) or holdover-out-of-spec (clockclass=165) state which is decide by the holdoverBudget. During the T-GM is recovering, the clockclass of the T-GM is decided by the software or hardware designing. With either one of the embodiments of FIG. 12 and FIG. 13, the “wait-to-restore time” function is triggered. During this period, the T-GM is excluded from the BMCA list. After the timer expires, the T-GM can be joined into the BMCA list and be re-selected as the clock source.

In the second scenario, if the T-BC1 is restarted or upgraded as the requirement, the history of the received announce messages is cleared in the T-BC2. The T-BC2 enters into holdover-in-spec (clockclass=135) or holdover-out-of-spec (clockclass=165) state which is decide by the holdoverBudget. With the embodiment of FIG. 12, after the T-BC1 is recovered, the T-GM sends announce messages with clockclass 6 to the T-BC1, and the T-BC1 would select the T-GM as clock source immediately. This is also applicable to the scenario of process restart, PTP-Clock configuration changing, PTP-Port configuration changing. With the embodiment of FIG. 13, after the T-BC1 is recovered, the T-GM may send announce and sync messages to the T-BC1 and the T-BC1 may send delay-request to the T-GM and receive delay-response from the T-GM. After a predetermined time period (e.g. about 30 seconds), if it can be known from the sampled timestamps that the T-GM is stable enough, the T-BC1 would select the T-GM as clock source immediately.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a network device, comprising:
determining whether the network device is in one of a first state where a reception of an announce message from a precision time protocol (PTP) clock source is interrupted due to a local change at the network device, and a second state where the PTP clock source is restored after a predetermined restoration time, or the reception of the announce message from the PTP clock source is recovered after the local change; and
when determining that the network device is in one of the first state and the second state, using 404) the PTP clock source as a candidate PTP master, without waiting for the predetermined restoration time.

2. The method according to claim 1, further comprising:
when determining that the network device is not in one of the first state and the second state, using the PTP clock source as a candidate PTP master after the PTP clock source is restored based on the predetermined restoration time.

3. The method according to claim 1, wherein whether the network device is in one of the first state and the second state is determined based on a state machine of the network device; and
wherein the state machine is configured to switch between the first state, the second state, and a third state where the reception of the announce message from the PTP clock source is interrupted due to an external change that is external to the network device, and a fourth state where the reception of the announce message from the PTP clock source is recovered but the predetermined restoration time has not elapsed.

4. The method according to claim 3, wherein the state machine has a parameter indicating, for the fourth state, remaining time required for restoring the PTP clock source; and
wherein the parameter takes a value that equals the predetermined restoration time when the fourth state is entered, and decreases with time.

5. The method according to claim 1, wherein determining whether the network device is in one of the first state and the second state comprises:
when the reception of the announce message from the PTP clock source is recovered after it is interrupted, determining offsets between a clock of the network device and a clock of the PTP clock source for a predetermined time period, based on timestamps related to PTP messages communicated between the network device and the PTP clock source; and
determining whether the network device is in the second state, based on the offsets determined in the predetermined time period.

6. The method according to claim 5, wherein the network device is determined to be in the second state when the offsets determined in the predetermined time period are within a predetermined range.

7. The method according to claim 1, wherein the local change comprises one or more of:
the network device being reloaded;
a line card of the network device being reloaded;
a process related to PTP in the network device being restarted;
a configuration of a PTP port of the network device being changed; and
a configuration of a PTP clock of the network device being changed.

8. The method according to claim 1, wherein using the PTP clock source as a candidate PTP master comprises:
adding an announce message from the PTP clock source into a best master clock algorithm (BMCA) list.

9. The method according to claim 1, wherein the network device is configured to act as one of:
a boundary clock (BC);
an ordinary clock (OC); and
a transparent clock (TC).

10. A network device comprising:
at least one processor; and
at least one memory, the at least one memory containing instructions executable by the at least one processor, whereby the network device is operative to:
determine whether the network device is in one of a first state where a reception of an announce message from a precision time protocol (PTP) clock source is interrupted due to a local change at the network device, and a second state where the PTP clock source is restored after a predetermined restoration time, or the reception of the announce message from the PTP clock source is recovered after the local change; and
when determining that the network device is in one of the first state and the second state, use the PTP clock source as a candidate PTP master, without waiting for the predetermined restoration time.

11. The network device according to claim 10, wherein the network device is further operative to:
when determining that the network device is not in one of the first state and the second state, use the PTP clock source as a candidate PTP master after the PTP clock source is restored based on the predetermined restoration time.

12. The network device according to claim 10, wherein the network device is operative to determine whether the network device is in one of the first state and the second state based on a state machine of the network device; and
wherein the state machine is configured to switch between the first state, the second state, a third state where the reception of the announce message from the PTP clock source is interrupted due to an external change that is external to the network device, and a fourth state where the reception of the announce message from the PTP clock source is recovered but the predetermined restoration time has not elapsed.

13. The network device according to claim 12, wherein the state machine has a parameter indicating, for the fourth state, remaining time required for restoring the PTP clock source; and
wherein the parameter takes a value that equals the predetermined restoration time when the fourth state is entered, and decreases with time.

14. The network device according to claim 10, wherein the network device is operative to determine whether the network device is in one of the first state and the second state by:
when the reception of the announce message from the PTP clock source is recovered after it is interrupted, determining offsets between a clock of the network device and a clock of the PTP clock source for a predetermined time period, based on timestamps related to PTP messages communicated between the network device and the PTP clock source; and
determining whether the network device is in the second state, based on the offsets determined in the predetermined time period.

15. The network device according to claim 14, wherein the network device is determined to be in the second state when the offsets determined in the predetermined time period are within a predetermined range.

16. The network device according to claim 10, wherein the local change comprises one or more of:
the network device being reloaded;
a line card of the network device being reloaded;
a process related to PTP in the network device being restarted;
a configuration of a PTP port of the network device being changed; and
a configuration of a PTP clock of the network device being changed.

17. The network device according to claim 10, wherein the network device is operative to use the PTP clock source as a candidate PTP master by:
adding an announce message from the PTP clock source into a best master clock algorithm (BMCA) list.

18. The network device according to claim 10, wherein the network device is configured to act as one of:
a boundary clock (BC);
an ordinary clock (OC); and
a transparent clock (TC).

19. A computer readable storage medium storing thereon instructions which when executed by at least one processor, cause the at least one processor to perform steps comprising:
determining whether the network device is in one of a first state where a reception of an announce message from a precision time protocol (PTP) clock source is interrupted due to a local change at the network device, and a second state where the PTP clock source is restored after a predetermined restoration time, or the reception of the announce message from the PTP clock source is recovered after the local change; and
when determining that the network device is in one of the first state and the second state, using the PTP clock source as a candidate PTP master, without waiting for the predetermined restoration time.
